(19) United States
(12) Patent Application Publication
(10) Pub. No.: US 2015/0356614 A1
(43) Pub. Date: Dec. 10, 2015

(54) Method for displaying advertising and task reminders on a portable electronic device

(71) Applicant: Iouri Makedonov, Toronto (CA)

(72) Inventor: Iouri Makedonov, Toronto (CA)

(21) Appl. No.: 14/296,346

(22) Filed: Jun. 4, 2014

(51) Int. Cl. G06Q 30/02; G06Q 10/10

(52) U.S. Cl. CPC G06Q 30/0267; G06Q 10/1097

(57) ABSTRACT

A system and method for displaying advertising, task reminders and other information is provided. Advertising, reminders for these tasks and other information are displayed when the user is looking at the device and is not busy with other tasks.

### CROSS REFERENCES TO RELATED APPLICATIONS

This application claims the benefit of the provisional patent applications by the present inventor: No. 61/831,604, filed on Jun. 5, 2013 and No. 61/842,041, filed on Jul. 2, 2013.

### BACKGROUND

### Prior Art

The following is a tabulation of some prior art that presently appears relevant:

U.S. patents

| Pat. No. | Kind Code | Issue Date | Patentee |
|---|---|---|---|
| 7,881,283 | B2 | Feb. 11, 2011 | Cormier etc. |
| 8,700,469 | B2 | Apr. 15, 2014 | Pisaris-Henderson etc. |
| 8,688,517 | B2 | Apr. 1, 2014 | Lutnick etc. |
| 8,285,337 | B1 | Oct. 9, 2012 | Gil etc. |

U.S. Patent Application Publications

| Publication Nr | Kind Code | Publ. Date | Applicant |
|---|---|---|---|
| 2012/0311583 | A1 | Dec. 6, 2012 | Gruber etc. |
| 2012/0309363 | A1 | Dec. 6, 2012 | Gruber etc. |
| 2012/0315876 | A1 | Dec. 13, 2012 | Srinivasan. |

Foreign Patent Documents

| | | | | |
|---|---|---|---|---|
| Foreign Doc. Nr | Country Code | Kind Code | Publ. Date | App or Patentee |

### Nonpatent Literature Documents

http://www.google.com web site

ASTRO File Manager Android app

### FIELD OF THE INVENTION

The present invention relates to display of information on portable electronic devices and, more particularly, to display of advertising and task reminders.

### BACKGROUND

Different ways of displaying advertising and task reminders on portable electronic devices are used. A message can be displayed over the first page of a web site or over the first screen of an application. Sometimes a small pop-up message box or a large flash screen is displayed at a predefined or random time. Alternating messages can also be displayed in a small area on the left side, right side or bottom of the screen.

These approaches are often not effective because:
when advertising is displayed over a web page or an application screen, a person may be irritated that the information he was looking for is blocked by displayed advertising. As a result he would try to dismiss displayed advertising as quickly as possible and may not even look at it.
when advertising is displayed on the side or bottom of the screen, a person may not even notice it due to tunnel vision and focus on the task he was performing when the advertising was displayed.

The purpose of the current invention is to display advertising and other information in a manner that would decrease the person's irritation and would increase the likelihood that the displayed advertising or task reminder is actually noticed, understood and followed.

### BRIEF SUMMARY OF THE INVENTION

The present invention comprises a method to display information such as advertising and task reminders on a portable electronic device.

Advertising, task reminders and other information is displayed when a person looks at a device and is not busy with other tasks. One or more of the following events is used to trigger the display of advertising and/or the task reminder: a) device screen is unlocked, b) device is awakened from sleep mode, c) device is powered on, d) external power cable is connected, e) external power cable is disconnected, f) external data interface is connected, g) external data interface is disconnected, h) phone call is terminated, i) clock alarm is turned off, j) clock alarm is snoozed, k) another application is closed, l) the home screen of an electronic device is displayed.

### BRIEF DESCRIPTION OF THE DRAWINGS

FIG. 1 shows the high level architecture of the system for displaying advertising and task reminders according to an embodiment of the invention;

FIG. 2 shows a sample display of a task reminder;

FIG. 3 shows a sample display of advertising; and

FIG. 4 shows a sample display of a task reminder together with advertising.

### DETAILED DESCRIPTION AND BEST MODE OF IMPLEMENTATION

The present invention will now be described more fully with reference to the accompanying drawings, in which preferred embodiments of the invention are shown. The invention may, however, be embodied in different forms and should not be construed as limited to the embodiments set forth herein.

Advertising and/or task reminders are displayed when the user is looking at the device and is not busy with other tasks. One or more of the following events is used to trigger the display of advertising and/or the task reminder: a) device screen is unlocked, b) device is awakened from a sleep mode, c) device is powered on, d) external power cable is connected, e) external power cable is disconnected, f) external data interface is connected, g) external data interface is disconnected, h) phone call is terminated, i) clock alarm is turned off, j) clock alarm is snoozed, k) another application is closed, l) the home screen of an electronic device is displayed.

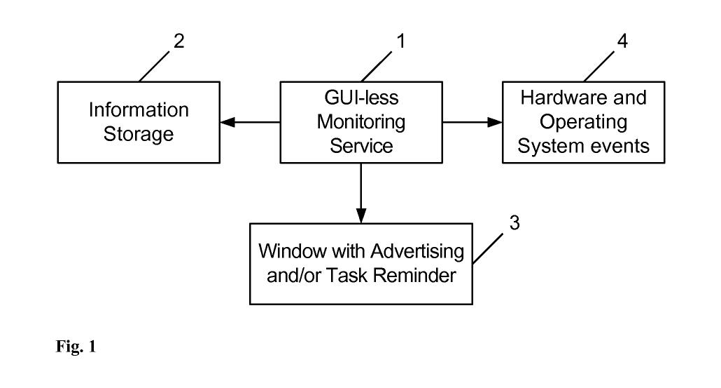

High level architecture of a system implementing this invention is shown in FIG. 1. It includes GUI-less service 1, Information storage 2 and a window with displayed information 3. Service 1 monitors one or more events documented above 4. In case a monitored event has happened this service shows a window 3 displaying advertising, task reminder or other information from the Information Storage 2.

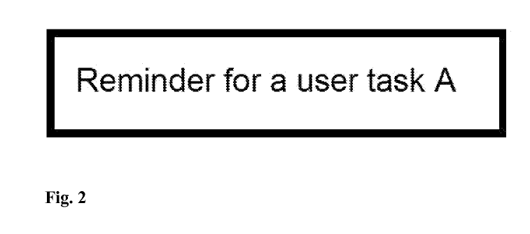

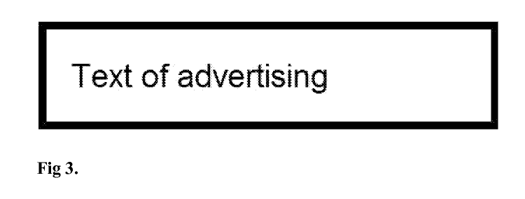

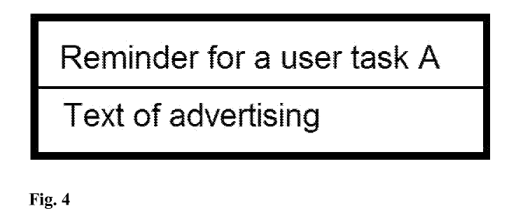

This window can display a task reminder as shown in FIG. 2, advertising as shown in FIG. 3, a task reminder together with advertising as shown in FIG. 4 or another type of information.

The user can close this window. By tapping on a task reminder the user can display the list of tasks. By tapping on advertising the user can display additional information related to displayed advertising such as video clip, additional web page or an advertised web site.

This window will automatically close if there is no user input within a predefined time.

The advantages of the present invention include, without limitation, that reminders and advertising are displayed when a person is most likely not busy with other activities, thus decreasing the user's irritation and increasing the chance of noticing and following displayed advertising.

Further a To-Do list application that serves as a source of task reminders is described.

Tasks in this To-do list may belong to different categories. A sample list of Categories is shown on FIG. 1. In this list, the user can:
add and delete a Category,
change the description of a Category,
increase or decrease the priority of a category (with higher priority categories presented at the top of this list)
change the status of a Category,
change the Filter to show Categories with different statuses,
display the list of tasks for a particular category,
user can scroll up and down the list of categories in case there are many categories in a list and the full list of categories does not fit on a single screen

A sample list of Tasks is shown on FIG. 2. In this list, the user can:
add and delete a Task,
change the description of a Task,
increase or decrease the priority of a task (with higher priority tasks presented at the top of this list)
change the status of a Task,
change the Filter to show Tasks with different statuses,
display a list of categories,
user can scroll up and down the list of tasks in case there are many tasks in a list and the full list of tasks does not fit on a single screen
   Tasks may be grouped under several Categories or may not have any associated Category at all.

Category may have one of the following statuses:
Active
Inactive

Task may have one of the following statuses:
Active
Inactive
Completed
Deleted

Each task and category has an assigned priority. Priority is expressed as an integer value with “1” being the highest priority, “2” being second highest priority and so on. These values are assigned to Categories and Tasks automatically when they are created and are automatically recalculated when the user changes priorities of Categories and Tasks using “Arrow Up” and “Arrow Down” icons.

Reminders for these tasks are displayed when the user is looking at the device and is not busy with other tasks. One of the following events is used to trigger the display of a reminder: a) device screen is unlocked, b) device is awakened from a sleep mode, c) device is powered on, d) external power cable is connected, e) external power cable is disconnected, f) external data interface is connected, g) external data interface is disconnected, h) phone call is terminated, i) clock alarm is turned off, j clock alarm is snoozed, k) another application is closed, l) the home screen of an electronic device is displayed.

Reminders are only displayed for Active tasks in Active categories (if Categories are defined).

The user can select one of several algorithms to determine the sequence of reminders. The possible algorithms are:
Random selection of a task to show a reminder
Round-robin through Categories—a reminder is shown for a task in the highest priority Category, then for a task in the second highest priority, then for a task in a third highest priority Category etc.; after one task from each category is displayed as a reminder, the same cycle through all Categories is repeated and so on,
Round-robin through Tasks—an overall priority for each task is calculated based on the priority of the task within its category and the priority of its Category. Reminders are displayed starting with the task with highest overall priority and then for remaining tasks with progressively decreasing overall priority until reminders are shown for all tasks; then the same cycle through all tasks is repeated and so on,
Priority biasing algorithm—display of reminders is started in the same order as “Round-robin through tasks” or “Round-robin through categories”. Before reminders for all tasks have been displayed, the sequence is interrupted and a reminder for a higher priority task is displayed again. Thus reminders for higher priority tasks and categories are displayed more frequently than for lower priority tasks and categories. A reminder for the task with lowest priority may not be displayed at all.

What is claimed is:

1. A method for displaying advertising and task reminders on a portable electronic device comprising:
a. providing one or more sources of the advertising and task reminders to be displayed,
b. monitoring by an electronic device for one or more of the following events: a) device screen is unlocked, b) device is awakened from sleep mode, c) device is powered on, d) external power source is connected, e) external power source is disconnected, f) external data interface is connected, g) external data interface is disconnected, h) phone call is terminated, i) clock alarm is turned off, j) clock alarm is snoozed, k) another application is closed, l) the home screen of an electronic device is displayed,
c. on detection of one or more of the above events, retrieving advertising and task reminders from the source and displaying them on the device.

2. The method of claim 1 wherein only advertising is displayed.

3. The method of claim 1 wherein only task reminders are displayed.

4. The method of claim 1 wherein both advertising and task reminders are displayed.

5. The method of claim 2 wherein said source of advertising is located on said electronic device.

6. The method of claim 2 wherein said source of advertising is accessed over the Internet.

7. The method of claim 3 wherein said source of task reminders is located on said electronic device.

8. The method of claim 3 wherein said source of task reminders is accessed over the Internet.

9. The method of claim 4 wherein said source of advertising and task reminders is located on said electronic device.

10. The method of claim 4 wherein said advertising and task reminders are accessed over the Internet.

11. The method of claim 4 wherein said advertising and task reminders are retrieved from the local device and over the Internet.

12. The method of claim 3 wherein a user can select one of several algorithms to determine the sequence of said reminders:
a. random selection of a task to show a reminder,
b. round-robin through categories—a reminder is shown for a task in the highest priority category, then for a task in the second highest priority, then for a task in a third highest priority category etc.; after one task from each category is displayed as a reminder, the same cycle through all categories is repeated and so on,
c. round-robin through tasks—an overall priority for each task is calculated based on the priority of the task within its category and the priority of its category; reminders are displayed starting with the task with highest overall priority and then for remaining tasks with progressively decreasing overall priority until reminders are shown for all tasks; then the same cycle through all tasks is repeated and so on,
d.—priority biasing algorithm—display of reminders is started in the same order as “round-robin through tasks” or “round-robin through categories”; before reminders for all tasks have been displayed, the sequence is interrupted and a reminder for a higher priority task is displayed again; thus reminders for higher priority tasks and categories are displayed more frequently than for lower priority tasks and categories.
